(19) United States
(12) Patent Application Publication
(10) Pub. No.: US 2020/0409927 A1
(43) Pub. Date: Dec. 31, 2020

(54) CROSS-DATABASE PLATFORM SYNCHRONIZATION OF DATA AND CODE

(71) Applicant: YRC Worldwide Inc., Overland Park, KS (US)

(72) Inventor: Doug Deppen, Overland Park, KS (US)

(21) Appl. No.: 16/946,561

(22) Filed: Jun. 26, 2020

Related U.S. Application Data
(60) Provisional application No. 62/867,725, filed on Jun. 27, 2019.

(51) Int. Cl. G06F 16/23; G06F 16/2457; G06F 16/2453; G06F 16/22; G06F 16/2452; G06F 16/27

(52) U.S. Cl. CPC G06F 16/235; G06F 16/24573; G06F 16/27; G06F 16/2282; G06F 16/2452; G06F 16/24534

(57) ABSTRACT

A computing system architecture includes a first database platform and a second database platform, wherein the first database platform is foreign to the second database platform. The architecture also includes an update to a data of the first database platform and a first transformation engine. The first transformation engine transforms the update from a first form native to the first database platform to a second form native to the second database platform using intelligence related to the first form and the second form.

### FIELD OF THE DISCLOSURE

The present invention relates generally to computer architecture and internet infrastructure for cross-platform database data synchronization. More particularly, the present invention relates to data synchronization between at least two database platforms that are foreign to each other.

### BACKGROUND

A database hosts massive amounts of data. When an operator of a database desires to switch the database operation from a first database platform, e.g., Linux or Model204, to a second database platform, e.g., SQLServer, the traditional process is to copy all the data from the first platform; store the data somewhere else for cleaning, transforming, and processing; shutdown the first platform; transplant all the data to the second platform; test the second platform; if something does not work, go back to the first platform and start over; and, finally, initiate the second platform. This traditional process creates inevitable interruption of the services provided by the operator of the databases and potential loss of data. The interruption can be as long as weeks. In modern business, almost all electronic transactions are provided 24 hours a day, non-stop. Most businesses cannot accept any interruption, not even seconds, let along interruption from days to weeks. This makes it extremely difficult for businesses to move a database system from one platform to another. Therefore, improvements are desirable.

### SUMMARY

The embodiments of the invention disclosed herein are directed to increase the interoperability across different database platforms. More specifically, the embodiments disclosed herein provide solutions to cross-platform database synchronization of data. The embodiments have many applications. One example of the application is that, with such a computational architecture, a migration from a first database platform to a second can be done with no interruption. In other words, at the front end, users experience continuous service, while, at the back end, the database is migrating from a first platform to a second. Further, the embodiments of the invention disclosed herein increases the computational efficiency by reducing and filtering out the redundant or expired data records.

The present invention relates generally to computer architecture and network infrastructure for cross-platform database data synchronization. More particularly, the present invention relates to data synchronization between at least two database platforms that are foreign to each other.

According to one embodiment, a computing system architecture includes a first database platform and a second database platform, wherein the first database platform is foreign to the second database platform. The computing system architecture includes an update to a data of the first database platform. A communication middleware receives the update from the first database platform and sends the update to the second database platform. The architecture includes a first transformation engine. The first transformation engine transforms the update from a first form native to the first database platform to a second form native to the second database platform using intelligence related to the first form and the second form.

According to another embodiment, a method for operating a computing architecture, comprises receiving, by a processor of a first database platform, an update to a data record wherein the update is in a first form, wherein the first form is operable on the first database platform; sending, by the processor, the update to a communication middleware; storing, by the processor, the update to a legacy database, wherein the legacy database has access to intelligence related to the firm form and the second form; and transforming, by the processor, the update from the first form to a second form using the intelligence, wherein the second form is not operable on the first database platform.

According to another embodiment, a method of causing data being written to a first platform to also be written to a second platform includes monitoring, by a processor, a modification of a first code of a program; determining, by a processor, if the modification affects data in a first platform; and if the modification affects the data, inserting, by the processor, a second code into the program to enable writing of the data to a second platform. The first code causes the data to be written to the first platform and the second code causes the data to be written to the second platform such that data is written to both the first and second platform.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the concepts and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed systems and methods, reference is now made to the following descriptions taken in conjunction with the accompanying drawings.

FIG. 1 is a schematic block diagram of a network infrastructure and computing system architecture according to one embodiment of the disclosure.

FIG. 2 is a schematic block diagram of a computing architecture according to one embodiment of the disclosure.

FIG. 3 is an exemplary user interface for programmers according to one embodiment of the disclosure.

FIG. 4 is an exemplary user interface for clients according to one embodiment of the disclosure.

FIG. 5 is an exemplary new code report according to one embodiment of the disclosure.

FIG. 6 is an exemplary individual record of new data according to one embodiment of the disclosure.

FIG. 7 is an exemplary testing report according to one embodiment of the disclosure.

FIG. 8 is a block diagram illustrating a computer network according to one embodiment of the disclosure.

FIG. 9 is a block diagram illustrating a computer system according to one embodiment of the disclosure.

FIG. 10 is an exemplary method for transforming data from a first form to a second form according to one embodiment.

FIG. 11 is an exemplary data validation and commitment method according to one embodiment.

FIG. 12 is a flow diagram illustrating a method of inserting code into a program according to one embodiment of the disclosure.

### DETAILED DESCRIPTION

The term “engine” as used herein means a tangible device, component, or arrangement of components implemented using hardware, such as by an application specific integrated circuit (ASIC) or field-programmable gate array (FPGA), for example, or as a combination of hardware and software, such as by a processor-based computing platform and a set of program instructions that transform the computing platform into a special-purpose device to implement the particular functionality. An engine may also be implemented as a combination of the two, with certain functions facilitated by hardware alone, and other functions facilitated by a combination of hardware and software.

In an example, the software may reside in executable or non-executable form on a tangible machine-readable storage medium. Software residing in non-executable form may be compiled, translated, or otherwise converted to an executable form prior to, or during, runtime. In an example, the software, when executed by the underlying hardware of the engine, causes the hardware to perform the specified operations. Accordingly, an engine is physically constructed, or specifically configured (e.g., hardwired), or temporarily configured (e.g., programmed) to operate in a specified manner or to perform part or all of any operations described herein in connection with that engine.

Considering examples in which engines are temporarily configured, each of the engines may be instantiated at different moments in time. For example, where the engines comprise a general-purpose hardware processor core configured using software; the general-purpose hardware processor core may be configured as respective different engines at different times. Software may accordingly configure a hardware processor core, for example, to constitute a particular engine at one instance of time and to constitute a different engine at a different instance of time.

In certain implementations, at least a portion, and in some cases, all, of an engine may be executed on the processor(s) of one or more computers that execute an operating system, system programs, and application programs, while also implementing the engine using multitasking, multithreading, distributed (e.g., cluster, peer-peer, cloud, etc.) processing where appropriate, or other such techniques. Accordingly, each engine may be realized in a variety of suitable configurations, and should generally not be limited to any particular implementation exemplified herein, unless such limitations are expressly called out.

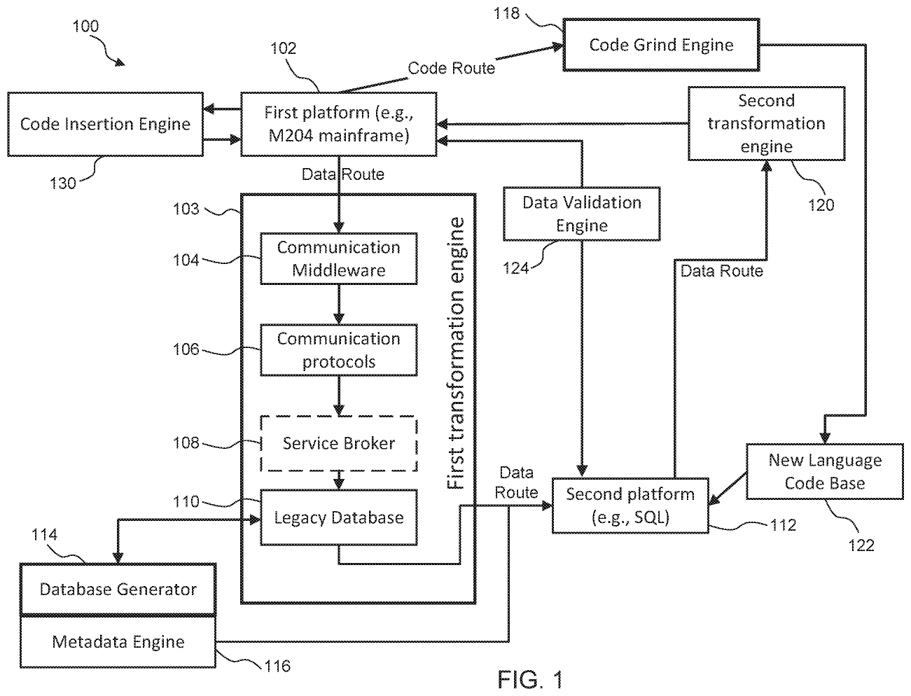

In addition, an engine may itself be composed of more than one sub-engine, each of which may be regarded as an engine in its own right. Moreover, in the embodiments described herein, each of the various engines corresponds to a defined functionality; however, it should be understood that in other contemplated embodiments, each functionality may be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein. The embodiments of FIG. 1 include various engines, e.g., a first transformation engine 103, a metadata engine 116, code grind engine 118, code insertion engine 130, second transformation engine 120, and data validation engine 124.

For a more complete understanding of the disclosed systems and methods, reference is now made to the following descriptions taken in conjunction with the accompanying drawings.

FIG. 1 is a schematic block diagram of a network infrastructure and computing system architecture 100, according to one embodiment of the disclosure. The architecture 100 includes a first platform 102, e.g., a M204 mainframe database. An M204 mainframe database is operated based on assembly language. The architecture 100 also includes a second platform 112, e.g., an SQL database. An SQL database is operated based on SQL compatible languages, e.g., C, C++, Java, etc. The first platform 102, e.g., M204, and the second platform 112, e.g., SQL, are foreign to each other and cannot directly communicate or share data. It is noted that M204 and SQL are illustrated in the embodiment of FIG. 1 as examples only and are not limiting the scope of the claims in any manner. The architecture 100 can migrate and/or synchronize all the data across the first platform 102 and the second platform 112, without any service interruption of either the first platform 102 or the second platform 112, while the first platform 102 and the second platform 112 are foreign to each other.

In general, each time a new program code is compiled and executed on the first platform 102 the same code is automatically reviewed for any instructions that may affect data, e.g. a write command. If instructions that affect data are found, new instructions are inserted into the code on the first platform 102 by a code insertion engine 130 that allow the data to also be written to the second platform 112 via a first transformation engine 103. (The data would also have been written to the first platform 102.) The first transformation engine 103 transforms the data of the first platform 102 to a form that is interoperable to the second platform 112.

The first transformation engine 103 includes communication middleware 104. The communication middleware 104 includes message queues. The communication middleware 104 supports sending and receiving messages between distributed systems, e.g., between the first platform 102 and the first transformation engine 103. The communication middleware 104 can distribute the data in the message queues to various receivers, e.g., a legacy database 110 that is distributed across a plurality of physical locations. The communication middleware 104 can distribute over heterogeneous platforms and reduce the complexity of developing applications that span multiple operating systems and communication protocols 106.

Communication protocols 106 includes various wired and/or wireless communication protocols. The communication protocols 106 may include transmission control protocols, user datagram protocols, automation protocols, Bluetooth protocols, electronic trading protocols, file transfer protocols, instant messaging protocols, internet protocols, Nortel protocols, open systems interconnection protocols, routing protocols, etc.

In one embodiment, the first transformation engine 103 sends the data received at the communication middleware 104 to an optional service broker 108 (as indicated with dashed box in FIG. 1) with appropriate communication protocols 106. In another embodiment, the first transformation engine 103 may send the data directly to the legacy database 110 without a service broker 108.

The legacy database 110 stores data from the first platform 102 to be transformed to the second platform 112. For the data of the first platform 102 to be interoperable on the second platform 112, the data format, table format, index format, data matrix, data processing rules, etc. need to be transformed. A database generator 114 transforms the data using a metadata engine 116 to transform the data received from the first platform 102 to a form that is operable on the second platform 112.

The database generator 114 pulls the data in a first form (e.g., the first form is operable on the first platform 102). The database generator 114 consults the metadata engine 116 to transform the data from the first form to the second form (e.g., the second form is operable on the second platform 112). The metadata engine 116 includes all the rules and intelligence of both the first data form and the second data form. The database generator 114 transforms the data from the first form to the second form according to the rules and intelligence provided by the metadata engine 116. The transformation done by the database generator 114 includes at least transforming data format, table format, index format, data matrix, data processing rules, etc. In one embodiment, the transformed data (in the second form) is stored in the legacy database 110 and then forwarded to the second platform 112. In another embodiment, the transformed data is forwarded to the second platform 112 by the database generator 114 and/or the metadata engine 116.

The first transformation engine 103 filters the data to eliminate redundancies. For example, the legacy database 110 may identify various versions of the data and keeps the latest version only because the latest version of the data includes previous changes, or the previous changes were over written and expired already. Thus, for example, the legacy database 110 might get 100 million records but only sends out 10 million records to the second platform 112. This data filtering process increases the computational efficiency for transformation to the second platform 112.

Each time a new programming code is executed on the first platform 102, the code insertion engine 130 recognizes the new addition of the code. The code insertion engine 130 inserts necessary code into the code to enable writing of the data to the second platform 112 in addition to the first platform 102. A code grind engine 118 can transform program code from the first platform 102 to the second platform 112. The code grind engine 118 does not operate on the data and is not the same as the code insertion engine 130. The code insertion engine 130 inserts code into the code for the first platform 102 so that the resulting code causes data to be not only written to the first platform 102 but also to the second platform 112 via the first transformation engine 103. The code grind engine 118 takes code for the first platform 102 and rewrites the code into a formation that is executable on the second platform 112.

A code base 122 ensures the new code, written by the code grind engine 118, is properly inserted into the correct section of the master program of the second platform 112, such that the second platform 112 produces the exact same result as the first platform 102 when executed. In such, regardless of whether a client is using the first platform 102 or the second platform 122, there is no difference as the data is being written to both platforms 102, 112 via the first transformation engine 103 and the code has been transformed via the code grind engine 118 to the second platform 112 for use on the second platform 112.

In addition, just like each time data is written to the first platform 102 the same data is transformed and inserted in the second platform 112 via the first transformation engine 103, vice versa is also true. Each time data is written on the second platform 112 (e.g., SQL database) it is transformed and inserted back to the first platform 102 (e.g., M204 database) through a second transformation engine 120.

A data validation engine 124 compares all the reports/records produced by the first platform 102 and the second platform 112 in a given day. The data validation engine 124 looks for any discrepancies between the first and second platforms 102, 112 and sends out an alert or report. The data validation engine 124 takes a snapshot of the first platform 102 and the second platform 112 at a predetermined time, e.g., 5:30 a.m. every day to look for such discrepancies.

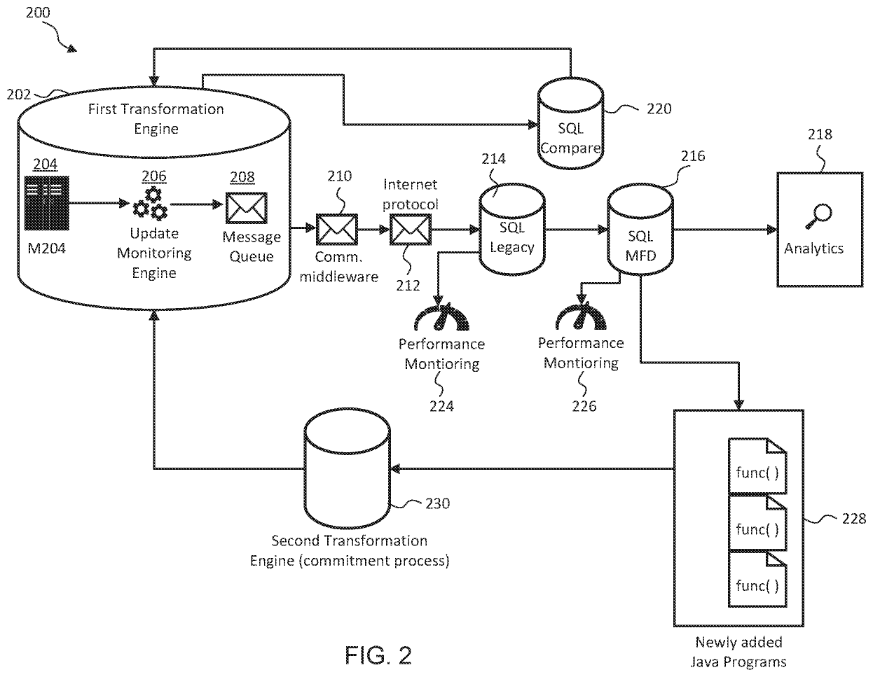

FIG. 2 is a schematic block diagram of a computing architecture 200 according to one embodiment of the disclosure. FIG. 2 can be an implementation of FIG. 1. The architecture 200 includes a first transformation engine 202. The first transformation engine 202 includes a first database 204 (hereinafter “database 204”), e.g., a M204 database. The first transformation engine 202 also includes update monitoring engine 206.

In one embodiment, a client and/or a programmer is using applications running on database 204. New data is added to the database 204. The update monitoring engine 206 checks for the newly added data. In one embodiment, the update monitoring engine 206 confirms the updates by checking data log. If the new data is added after a predetermined time, e.g., 24 hours ago, then the update monitoring engine 206 sends the new data to the message queue 208.

The message queue 208 organizes the updates. The message queue 208 sends the data to the communication middleware 210. The communication middleware 210 includes message queues. The message queues of the communication middleware 210 receives data from the database 204. The communication middleware 210 supports sending and receiving messages between distributed systems. The communication middleware 210 can distribute the data in the message queues to various receivers, e.g., SQL legacy database 214 that is distributed across a plurality of physical locations. The communication middleware 210 can distribute the data over heterogeneous platforms and reduce the complexity of developing applications that span multiple operating systems and communication protocols. The communication middleware 210 sends the data through internet protocol 212. For example, the SQL legacy database 214 receives the data from M204. Moreover, the SQL legacy database 214 stores the transformed data operable to the second platform 112.

For the data of the database 204 to be interoperable on the SQL mainframe database 216, the data format, table format, index format, data matrix, data processing rules, etc. need to be transformed. In one embodiment, the SQL legacy database 214 works with a database generator and metadata engine to transform the data received from the database 204 to a form that is operable on the SQL mainframe database 216. In another embodiment, the SQL legacy database 214 includes the database generator and metadata engine within itself.

In one embodiment, the database generator pulls the data in a first form (e.g., the first form is operable on M204). The database generator consults the metadata engine to transform the data from the first form to the second form (e.g., the second form is operable on the SQL database). The metadata engine includes all the rules and intelligence of both the first data form and the second data form. The database generator transforms the data from the first form to the second form according to the rules and intelligence provided by the metadata engine. The transformation done by the database generator includes at least transforming data format, table format, index format, data matrix, data processing rules, etc. In one embodiment, the transformed data (in the second form) is stored in legacy database and then forwarded to the SQL database 216.

The SQL legacy database 214 filters the data to eliminate redundancies. For example, the SQL legacy database 214 may identify various versions of the data and keeps only the latest version because the latest version of the data includes previous changes that do not matter anymore, e.g., the previous changes were over written and expired already. Thus, for example, the SQL legacy database 214 might get 100 million records but only sends out one tenth, i.e., 10 million records, to the SQL mainframe database 216. This data filtering process increases the computational efficiency for the SQL mainframe database 216. The numbers of records received by the SQL legacy database 214 is monitored by the performance monitoring engine 224. The numbers of records received by the SQL mainframe database 216 is monitored by the performance monitoring engine 226. Thus, comparing the performance monitoring engines 224 and 226, the exact number of reduction can be obtained, as well as the increases in computational efficiency can be observed.

System administrators may utilize various analytic tools 218 to make statistical analyses on the transformation of records. In one embodiment replacement tools 218 can be used to make further analyses. A user using SQL mainframe database 216 may add new data from java programs 228. The newly added data are not committed to the SQL mainframe database 216 until the second transformation engine 230 validates the data. Once the data is validated by the second transformation engine 230, the data will be committed, meaning the data with its appropriate forms (for M204 or SQL) are inserted into the database 204 and SQL mainframe 216.

SQL comparison engine 220 performs the data validation process by comparing all the reports/records produced by database 204 and SQL mainframe 216. The SQL comparison engine 220 looks for any discrepancies among the two systems and sends out an alert. SQL comparison engine 220 takes a snapshot of the database 204 and SQL mainframe database 216 at a predetermined time, e.g., 5:30 a.m. every day and compares the differences.

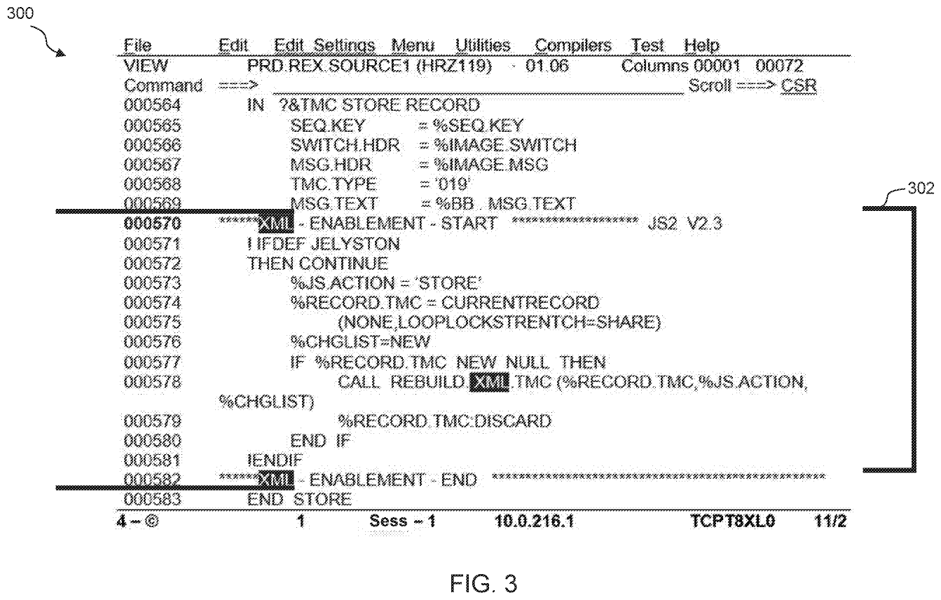

FIG. 3 is an exemplary interface 300 to code according to one embodiment of the disclosure. The interface 300 allows the code insertion engine 130 to add new code. The code insertion engine looks for code that modifies data. When such code is found, the code insertion engine 130 adds new code 302 to also allow the data to be written to a second platform, such as the second platform 112 of FIG. 1.

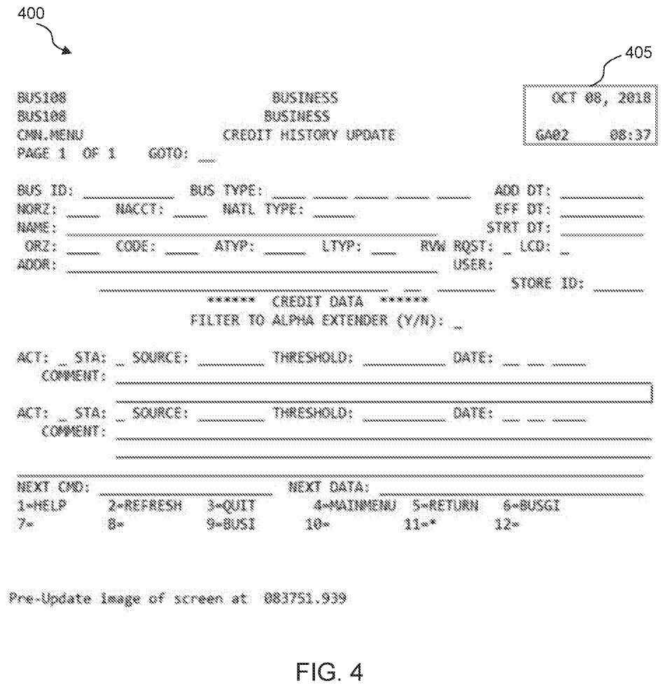

FIG. 4 is an exemplary user interface 400 for clients according to one embodiment of the disclosure. The user interface 400 is for clients to make orders. The user interface 400 includes a time stamp 405. New data is added to the database when clients submit an order using the user interface 400. In one embodiment, the new data can be added to the M204 system or SQL system. According to the time stamp 405, the computing architecture e.g., 100 or 200, will validate the data and sync data across platforms.

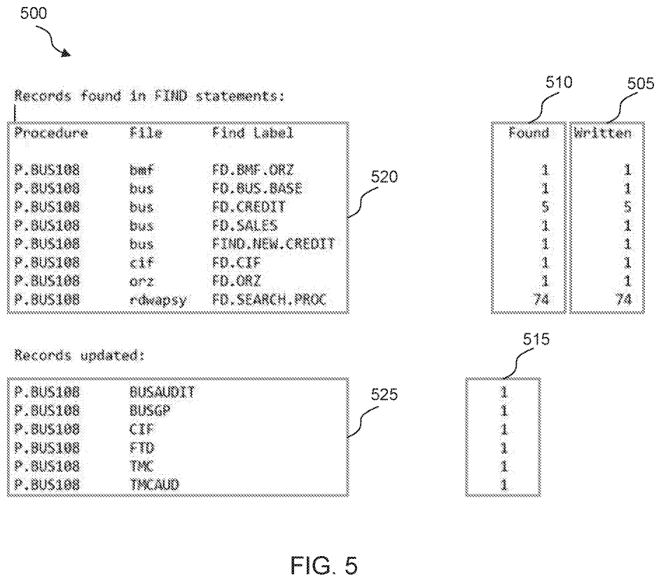

FIG. 5 is an exemplary new code report 500 according to one embodiment of the disclosure. In one embodiment, the new code report 500 reports the new code added during a predetermined time period, e.g., 24 hours. The report 500 includes section 505 showing log records that how many program files were written. The report 500 includes section 510 showing how many files were found to include new codes. The report 500 includes section 520 showing the file names of the program files being modified. The report 500 includes section 525 showing file names of data records being updated. The report 500 includes section 515 showing numbers of changes of each file of data records.

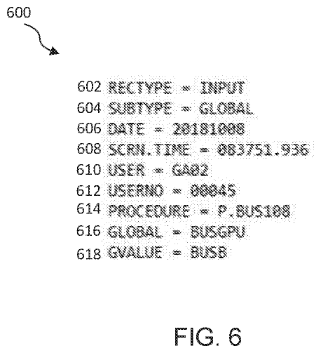

FIG. 6 is an exemplary individual record 600 of new data according to one embodiment of the disclosure. The record 600 includes record type 602, record sub type 604, date the record is created 606, snap shot time 608, user identification 610, user number 612, procedure/application program related to the record 614, global identifier for the record 616, and global value for the record 618.

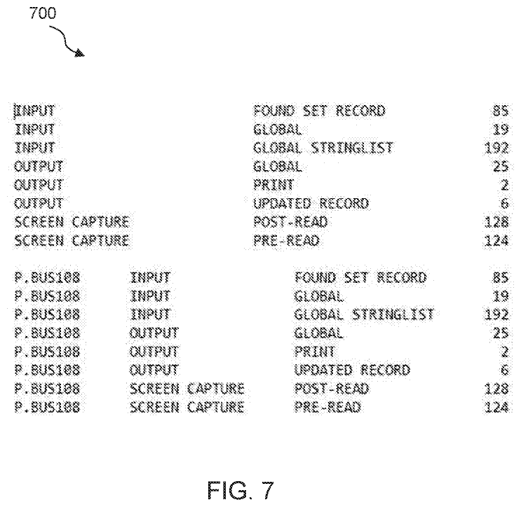

FIG. 7 is an exemplary testing report 700 according to one embodiment of the disclosure. The testing report 700 provides statistical numbers of new records inputted, new records outputted, new records screen-shot (snap-shot), etc. In one embodiment, this testing report can be generated by the data validation engine 124 or SQL compare engine 220. During testing, parameters of data changes and codes inserted are stored and reported such that the code synchronization can be mimicked outside of the environment to verify the results within the environment.

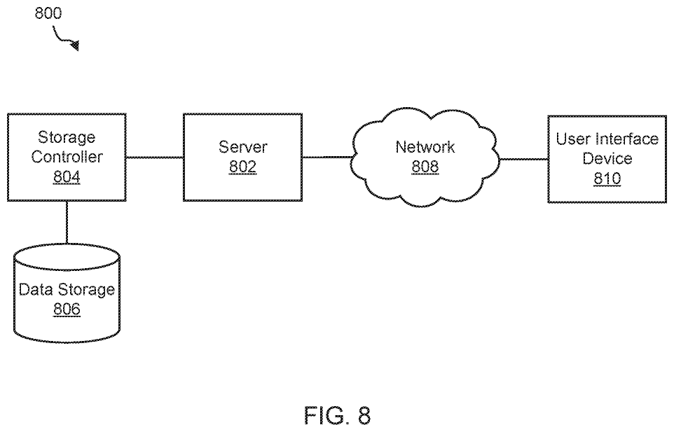

FIG. 8 illustrates a computer network 800 for obtaining access to database files in a computing system according to one embodiment of the disclosure. The computer network 800 may include a server 802, a data storage device 806, a network 808, and a user interface device 810. The server 802 may also be a hypervisor-based system executing one or more guest partitions hosting operating systems with modules having server configuration information. In a further embodiment, the system 800 may include a storage controller 804, or a storage server configured to manage data communications between the data storage device 806 and the server 802 or other components in communication with the network 808. In an alternative embodiment, the storage controller 804 may be coupled to the network 808.

In one embodiment, the user interface device 810 is referred to broadly and is intended to encompass a suitable processor-based device such as a desktop computer, a laptop computer, a personal digital assistant (PDA) or tablet computer, a smartphone or other mobile communication device having access to the network 808. The interface device 810 can be for the database backend for programmers and/or the frontend for clients. In a further embodiment, the user interface device 810 may access the Internet or other wide area or local area network to access a web application or web service hosted by the server 802 and may provide a user interface for enabling a user to enter or receive information.

The network 808 may facilitate communications of data between the server 802 and the user interface device 810. The network 808 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

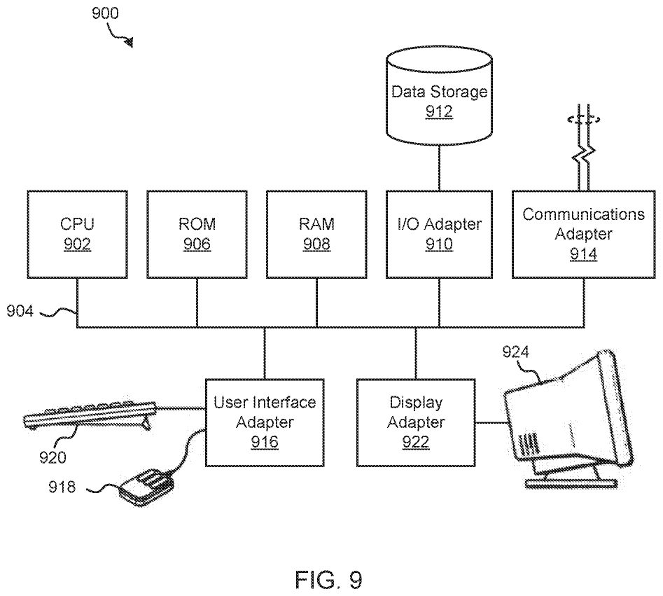

FIG. 9 illustrates a computer system 900 adapted according to certain embodiments of the server 802 and/or the user interface device 810. The central processing unit (“CPU”) 902 is coupled to the system bus 904. The CPU 902 may be a general purpose CPU or microprocessor, graphics processing unit (“GPU”), and/or microcontroller. The present embodiments are not restricted by the architecture of the CPU 902 so long as the CPU 902, whether directly or indirectly, supports the operations as described herein. The CPU 902 may execute the various logical instructions according to the present embodiments.

The computer system 900 may also include random access memory (RAM) 908, which may be synchronous RAM (SRAM), dynamic RAM (DRAM), synchronous dynamic RAM (SDRAM), or the like. The computer system 900 may utilize RAM 908 to store the various data structures used by a software application. The computer system 900 may also include read only memory (ROM) 906 which may be PROM, EPROM, EEPROM, optical storage, or the like. The ROM may store configuration information for booting the computer system 900. The RAM 908 and the ROM 906 hold user and system data, and both the RAM 908 and the ROM 906 may be randomly accessed.

The computer system 900 may also include an I/O adapter 910, a communications adapter 914, a user interface adapter 916, and a display adapter 922. The I/O adapter 910 and/or the user interface adapter 916 may, in certain embodiments, enable a user to interact with the computer system 900. In a further embodiment, the display adapter 922 may display a graphical user interface (GUI) associated with a software or web-based application on a display device 924, such as a monitor or touch screen.

The I/O adapter 910 may couple one or more storage devices 912, such as one or more of a hard drive, a solid state storage device, a flash drive, a compact disc (CD) drive, a floppy disk drive, and a tape drive, to the computer system 900. According to one embodiment, the data storage 912 may be a separate server coupled to the computer system 900 through a network connection to the I/O adapter 910. The communications adapter 914 may be adapted to couple the computer system 900 to the network 808, which may be one or more of a LAN, WAN, and/or the Internet. The user interface adapter 916 couples user input devices, such as a keyboard 920, a pointing device 918, and/or a touch screen (not shown) to the computer system 900. The display adapter 922 may be driven by the CPU 902 to control the display on the display device 924. Any of the devices 902-922 may be physical and/or logical.

The applications of the present disclosure are not limited to the architecture of computer system 900. Rather the computer system 900 is provided as an example of one type of computing device that may be adapted to perform the functions of the server 802 and/or the user interface device 910. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 900 may be virtualized for access by multiple users and/or applications.

If implemented in firmware and/or software, the functions described above may be stored as one or more instructions or code on a computer-readable medium. Examples include non-volatile computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

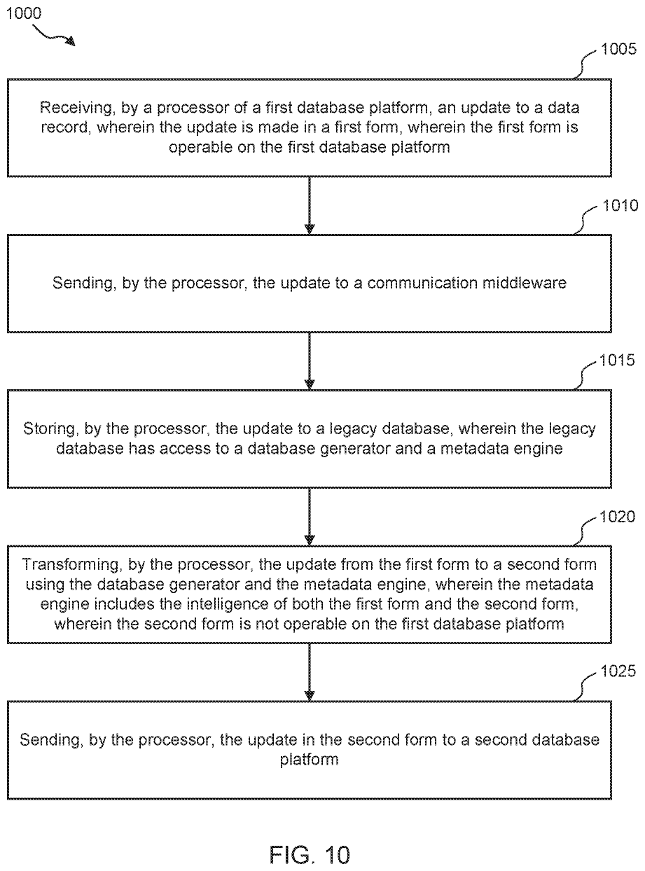

FIG. 10 shows a method 1000 for transforming data from a first form to a second form according to one embodiment. The method 1000 can be executed by the architecture 100 and architecture 200. The method 1000 includes 1005, receiving, by a processor of a first database platform, an update to a data record, wherein the update is made in a first form, wherein the first form is operable on the first database platform. In one embodiment, the first platform can be M204.

The method 1000 includes 1010, sending the update, by the processor, to a communication middleware. The method 1000 includes 1015 storing, by the processor, the update to a legacy database, wherein the legacy database has access to a database generator and a metadata engine. In one embodiment, the legacy database can be the database 110 or SQL legacy database 214.

The method 1000 includes 1020 transforming, by the processor, the update from the first form to a second form using the database generator and the metadata engine, wherein the metadata engine includes the intelligence of both the first form and the second form, wherein the second form is not operable on the first database platform.

The method 1000 includes 1025 sending, by the processor, the update in the second form to a second database platform. In one embodiment, the second database platform is SQL database.

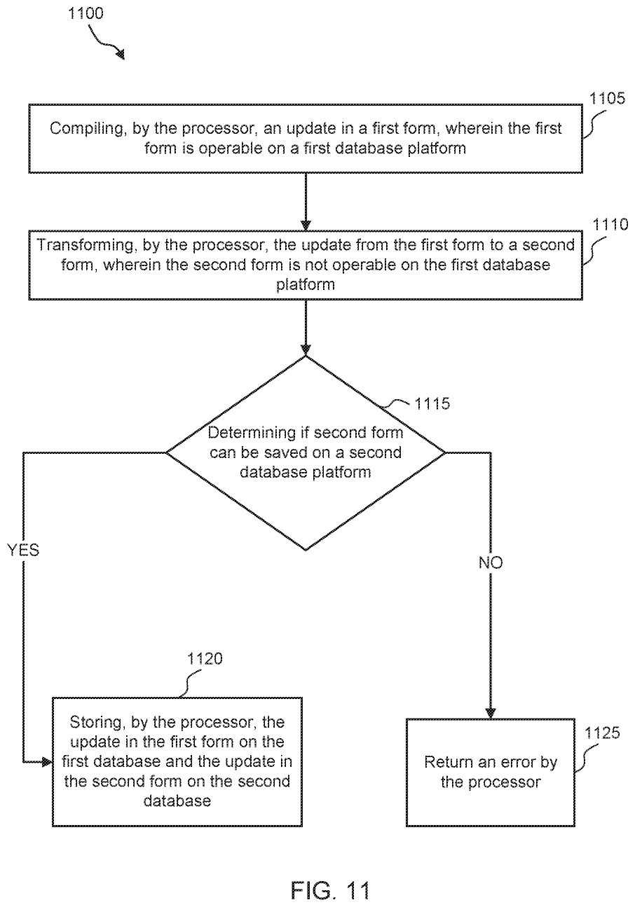

FIG. 11 shows a data validation and commitment method 1100 according to one embodiment. In one embodiment, unless the method 1100 is complete, no update in either first platform or second platform can be made. The method 1100 can be implemented in architecture 100 and/or 200.

The method 1100 includes 1105 compiling, by the processor, an update in a first form, wherein the first form is operable on a first database platform, e.g., a SQL database. The method 1100 includes 1110, transforming, by processor, the update from the first form to a second form operable on a second database platform, e.g., a M204 database. The method 1100 includes determining 1115, by the processor, if the update in the second form can be saved on the second database platform. If the update can be saved on the second database, storing 1120, by the process, the update in the second form on the second database and the update in the first form on the first database. If the update cannot be saved on the second database, return 1125 an error by the processor.

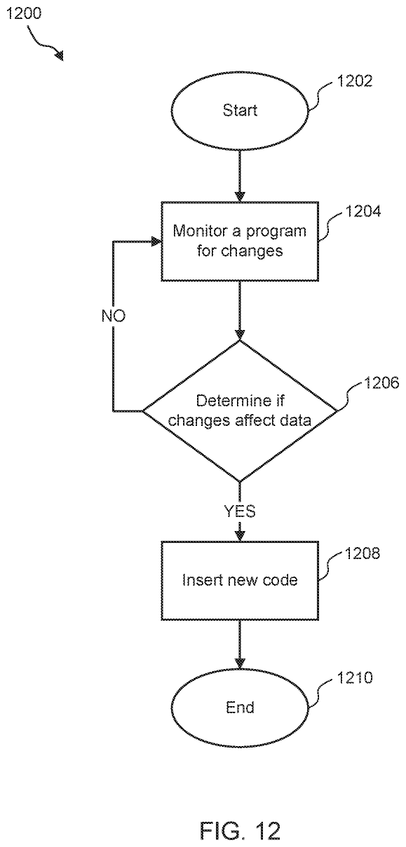

FIG. 12 is a flow diagram illustrating a method 1200 of inserting code into a program. The method 1200 begins at 1202. At 1204, a processor monitors a program for any changes to the program. At 1206, the processor determines if the changes to the program affect data being written to a first database. For example, a delete, copy, add or modify command. If the processor determines that the code does not affect the data, the flow branches “NO” back to 1204 and monitoring continues. If the processor determines that the change does affect data, the flow branches “YES” to 1208 and the processor inserts new code into the program to cause the data to also be written to a second database. The first and second database can be databases that are not compatible with each other. Flow ends at 1210.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method of causing data being written to a first platform to also be written to a second platform, the method comprising:
monitoring, by a processor, a modification of a first code of a program;
determining, by a processor, if the modification affects data in a first platform; and
if the modification affects the data, inserting, by the processor, a second code into the program to enable writing of the data to a second platform;
wherein the first code causes the data to be written to the first platform and the second code causes the data to be written to the second platform such the data is written to both the first and second platform.

2. The method of claim 1, further comprising identifying a first insertion point of the first code and identifying a second insertion point for the second code based on the first insertion point.

3. The method of claim 1, wherein the second code causes the data to be written to the second database in a manner consistent with the first code.

4. The method of claim 1, further comprising:
transforming by a first transformation engine, the data from a first form native to the first platform to a second form native to the second platform using intelligence for the first form and the second form.

5. The method of claim 4, wherein transforming includes the first transformation engine being accessible to a database generator and a table metadata engine.

6. The method of claim 1, wherein the first platform is based on assembly language.

7. The method of claim 1, wherein the second platform is based on structured query language (SQL).

8. The method of claim 1, wherein transforming includes the first transformation engine including communication protocols that are used to structure, at least in part, a communication between the first database platform and the second database platform.

9. A computing system architecture, comprising:
a first database platform;
a second database platform, wherein the first database platform is foreign to the second database platform;
an update to data of the first database platform; and
a first transformation engine, wherein the first transformation engine transforms the update from a first form native to the first database platform to a second form native to the second database platform using intelligence for the first form and the second form.

10. A computing system architecture according to claim 9, further comprising a communication middleware that receives the update from the first database platform and sending the update to the second database platform.

11. The computing system architecture according to claim 9, wherein the first transformation engine is accessible to a database generator and a table metadata engine.

12. The computing system architecture according to claim 9, wherein the first database platform is based on assembly language.

13. The computing system architecture according to claim 9, wherein the second database platform is based on structured query language (SQL).

14. The computing system architecture according to claim 9, the first transformation engine further including:
communication protocols which are used to structure, at least in part, a communication between the first database platform and the second database platform.

15. The computing system architecture according to claim 9, further including:
a code insertion engine, wherein the code insertion engine identifies a first insertion point of the update at the first database platform, the code insertion engine identifies a second insertion point of the update at the second database platform based on the first insertion point.

16. The computing system architecture according to claim 9, wherein the update is not committed until the update is transformed from the first form to the second form such that the update has the same effect on the second database platform as the first database platform.

17. The computing system architecture according to claim 9, further including:
a validation engine, wherein the validation engine takes snap-shots of the first database platform and the second database platform at a predetermined time, the validation engine compares a discrepancy between the snap-shots of the first database platform and the second database platform.

18. The computing system architecture according to claim 9, further including:
a second transformation engine accessible to the second database platform; and
a second update to a data of the second database platform,
wherein the second transformation engine transforms the second update from the second form to the first form.

19. The computing system architecture according to claim 9, wherein the second update is not committed until the second update is transformed from the second form to the first form such that the second update has the same effect on the first database platform as on the second database platform.

20. The computing system architecture according to claim 9, further including a legacy database that stores a first number of data records of the first database platform and sends a second number of data records to the second database platform, wherein the second number is smaller than the first number.
